(19) United States
(12) Patent Application Publication
(10) Pub. No.: US 2015/0309988 A1
(43) Pub. Date: Oct. 29, 2015

(54) Evaluating Crowd Sourced Information Using Crowd Sourced Metadata

(71) Applicant: International Business Machines Corporation, Armonk, NY (US)

(72) Inventors: Corville O. Allen, Morrisville, NC (US); Albert A. Chung, Cary, NC (US); Andrew R. Freed, Cary, NC (US); Dorian B. Miller, Cary, NC (US)

(73) Assignee: International Business Machines Corporation, Armonk, NY (US)

(21) Appl. No.: 14/264,992

(22) Filed: Apr. 29, 2014

(51) Int. Cl. G06F 17/27; G06N 7/00; G06F 17/30; G06N 5/04

(52) U.S. Cl. CPC G06F 17/2765; G06N 5/04; G06N 7/00; G06F 17/3053

(57) ABSTRACT

An approach is provided for utilizing crowd sourced data to score, or weigh, candidate answers in a question/answer (QA) system. In the approach, a question is received from a user and the system identifies question keywords and a context in the question using natural language processing (NLP). The system mines crowd sourced data sets for crowd sourced information, the mining being based on the identified question keywords and context. The crowd sourced data sets have stored therein a collective opinion of a crowd of individuals. The system evaluates the mined crowd sourced information based on crowd sourced metadata. The evaluation results in a most likely answer that is returned to the user, with the most likely answer that incorporating a portion of the crowd sourced information.

### BACKGROUND OF THE INVENTION

A Question/Answer System, such as the IBM Watson™ system is an artificially intelligent computer system capable of answering questions posed in natural language. While Question/Answer (QA) systems excel at retrieving facts from online sources, such as documents, newspapers, journals, and the like, these systems are challenged by crowd-based information, such as opinions, that are often not found in traditional online fact sources. Crowdsourcing obtains ideas from a large group of people, such as that found in an online community. While crowdsourcing may provide ideas from a variety of people, the trustworthiness of such information is often difficult to ascertain. The ideas may be spread across a number of websites and not consolidated into a single source. In addition, the acceptance or trustworthiness of an idea or opinion by others in the online community may be difficult to determine. The various websites may use simple “like” and “follow” mechanisms to allow community members to agree with an idea, but these mechanisms are not normalized or standardized across the various sites.

### SUMMARY

An approach is provided for utilizing crowd sourced data to score, or weigh, candidate answers in a question/answer (QA) system. In the approach, a question is received from a user and the system identifies question keywords and a context in the question using natural language processing (NLP). The system mines crowd sourced data sets for crowd sourced information, the mining being based on the identified question keywords and context. The crowd sourced data sets have stored therein a collective opinion of a crowd of individuals. The system evaluates the mined crowd sourced information based on crowd sourced metadata. The evaluation results in a most likely answer that is returned to the user, with the most likely answer that incorporating a portion of the crowd sourced information.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a Question/Answer (QA) system that utilizes a knowledge base;

FIG. 2 is a block diagram of a processor and components of an information handling system such as those shown in FIG. 1;

FIG. 3 is a component diagram depicting the various components in evaluating crowd sourced information using crowd sourced metadata;

FIG. 4 is a depiction of a flowchart showing the logic used in the QA system using crowd sourced information to answer user questions;

FIG. 5 is a depiction of a flowchart showing the logic performed in creating a social search criteria to answer user questions;

FIG. 6 is a depiction of a flowchart showing the logic used in searching the knowledge base including crowd sourced information for candidate answers;

FIG. 7 is a depiction of a flowchart showing the logic performed in scoring candidate answers using crowd sourced information;

FIG. 8 is a depiction of a flowchart showing the logic performed in retrieving supporting evidence which utilizes crowd sourced information; and

FIG. 9 is a depiction of a flowchart showing the logic performed in scoring the evidence using crowd sourced information.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

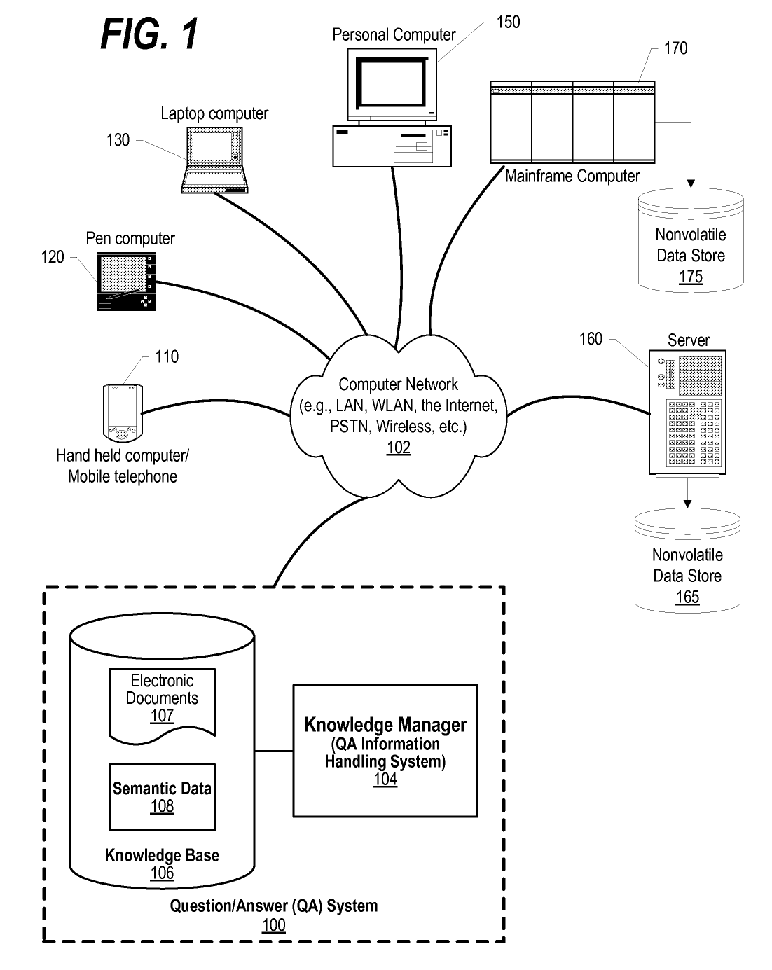

FIG. 1 depicts a schematic diagram of one illustrative embodiment of a question/answer creation (QA) system 100 in a computer network 102. Knowledge manager 100 may include a computing device 104 (comprising one or more processors and one or more memories, and potentially any other computing device elements generally known in the art including buses, storage devices, communication interfaces, and the like) connected to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. Knowledge manager 100 and network 102 may enable question/answer (QA) generation functionality for one or more content users. Other embodiments of knowledge manager 100 may be used with components, systems, sub-systems, and/or devices other than those that are depicted herein.

Knowledge manager 100 may be configured to receive inputs from various sources. For example, knowledge manager 100 may receive input from the network 102, a corpus of electronic documents 106 or other data, a content creator 108, content users, and other possible sources of input. In one embodiment, some or all of the inputs to knowledge manager 100 may be routed through the network 102. The various computing devices 104 on the network 102 may include access points for content creators and content users. Some of the computing devices 104 may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in a document 106 for use as part of a corpus of data with knowledge manager 100. The document 106 may include any file, text, article, or source of data for use in knowledge manager 100. Content users may access knowledge manager 100 via a network connection or an Internet connection to the network 102, and may input questions to knowledge manager 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. In one embodiment, the process sends well-formed questions (e.g., natural language questions, etc.) to the knowledge manager. Knowledge manager 100 may interpret the question and provide a response to the content user containing one or more answers to the question. In some embodiments, knowledge manager 100 may provide a response to users in a ranked list of answers.

In some illustrative embodiments, knowledge manager 100 may be the IBM Watson™ QA system available from International Business Machines Corporation of Armonk, N.Y., which is augmented with the mechanisms of the illustrative embodiments described hereafter. The IBM Watson™ knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The IBM Watson™ QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the IBM Watson™ QA system. The statistical model may then be used to summarize a level of confidence that the IBM Watson™ QA system has regarding the evidence that the potential response, i.e. candidate answer, is inferred by the question. This process may be repeated for each of the candidate answers until the IBM Watson™ QA system identifies candidate answers that surface as being significantly stronger than others and thus, generates a final answer, or ranked set of answers, for the input question. More information about the IBM Watson™ QA system may be obtained, for example, from the IBM Corporation website, IBM Redbooks, and the like. For example, information about the IBM Watson™ QA system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

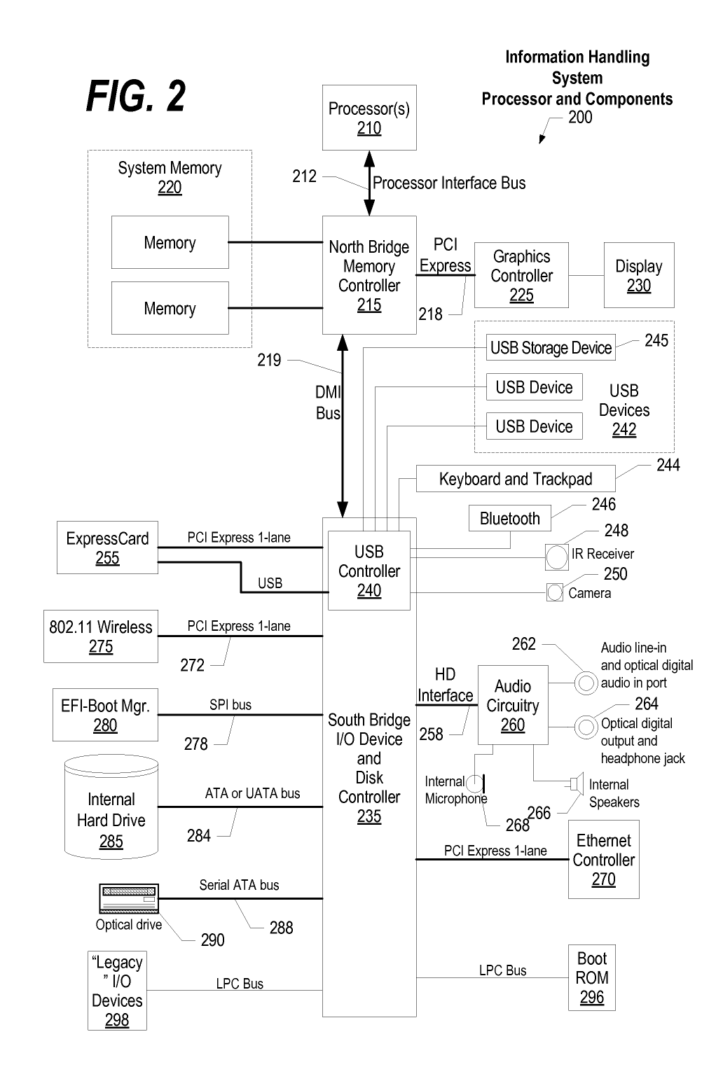

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 100. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

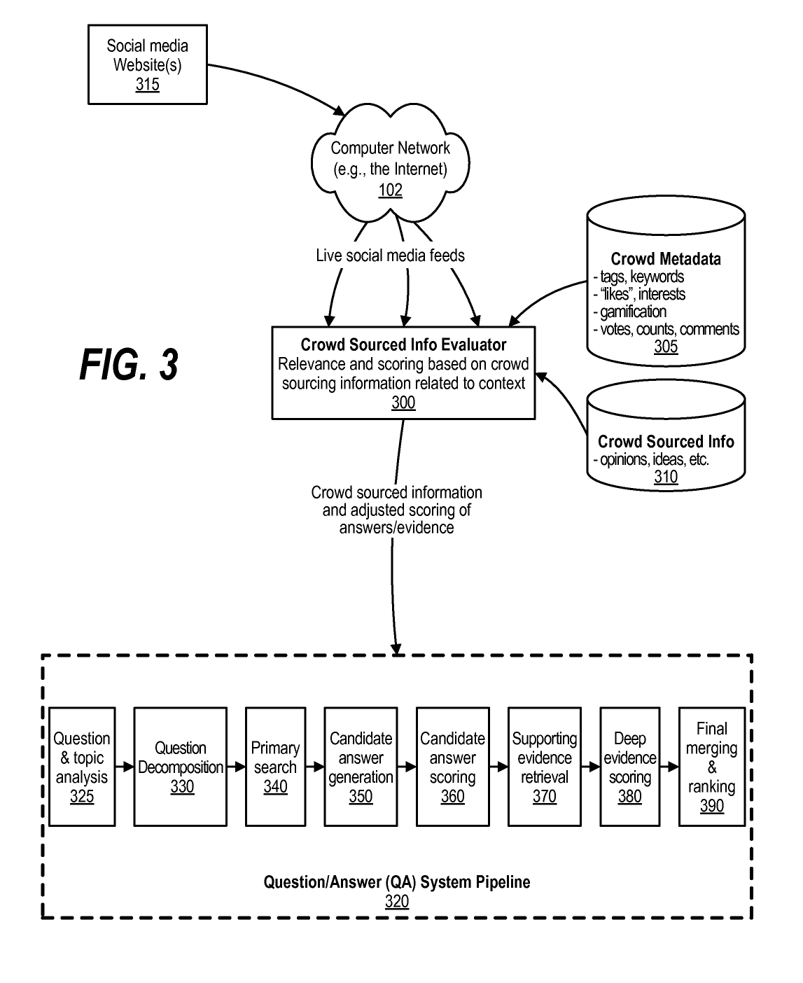

FIGS. 3-9 depict an approach that can be executed on an information handling system, to utilize crowd sourced metadata to evaluate crowd sourced information in a Question/Answer (QA) system, such as QA System 100 shown in FIG. 1. The approach described herein utilizes crowd sourced information to dynamically impact relevance and features for a question in a given context to better determine a more accurate answer and elevating the appropriate supporting evidence. This approach uniquely uses crowd sourced information dynamically within a Question and Answer (QA) system, such as QA System 100 shown in FIG. 1. Social information's impact on decisions provide more accurate answers and supporting evidence that more closely coincide with crowd based data for many types of questions, such as those questions where an opinion or idea is desired rather than a proven fact.

During evidence analysis and relevance scoring once the terms and answer types are defined within the context, the approach develops a social search criteria for crowd sourced information. The system retrieves crowd sourced metadata such as social keywords and tags relevant to the context, terms and answer type. Based on the tag weights for the crowd for the information, the approach adjusts the scores for features and the source content thus increasing their positive weight. The system further determines crowd based answer that match the answer type and the question type. The system then matches that against crowd sourced information, increases the weight of the features or relevance of the evidence based on the social support relating to the evidence, such as votes, interests, or follows in a particular crowd of information.

While evaluating evidence evaluation and relevance scoring for terms and answer types in a context, the system creates a social search criteria to find crowd sourced information. In doing so, the system determines the tags to search for as well as the terms and synonyms for the context or answer type. The system searches the crowd sourced information retrieving the crowd sourced metadata. The crowd sourced metadata might include tags relevant in that social network, the number of social bookmarks (e.g., “likes,” follows, trending, etc.), historical trending, and views (e.g., direct views, references, comments, etc.) and these tags are used to derive the social support of an idea. The derived social support is then used as a weighting factor that influences the candidate answers related to the question posed by a user. Using the crowd sourced metadata, the system increases the weights/scores of features depending on the type of answer. For higher weighted social tags that match the answer type, the system adjusts the relevance for the corpora and adjust the weight of the features associated with that term. Based on the social support which is normalized across various crowd sources, the system adjusts the weight of the corpora or supporting evidence. Because crowd metadata is a dynamic factor (e.g., “likes,” trending, etc.) that can change on a day-to-day basis, the answers provided by the QA system are influenced by this real-time factor that indicates the social support relating to candidate answers. In this manner, crowd sourced data differs from other types of data because the crowd sourced data can be used to derive the social support of an idea, opinion, or other type of possible answer. As used herein, “social support” includes any of a multitude of ways that crowd sourced data sources (e.g., websites, etc.) indicate the popularity, agreement, or support of an idea, opinion, or other type of answer (e.g. “likes,” follows, votes, etc.). The system utilizes other crowd sourced metadata to dynamically adjust feature scores or relevance. Based on the adjusted weight, influence of the supporting evidence, and associated features, the system identifies the best, or most likely, answer in a final scoring/merging process. The scoring and final merger provides the final answer which was more influenced by the crowd sourced corpora and features. This final answer is returned to the user as the most likely answer.

FIG. 3 is a component diagram depicting the various components in evaluating crowd sourced information using crowd sourced metadata. Crowd sourced information evaluator 300 is a process, or processes, that utilizes crowd sourced metadata 305 to evaluate crowd sourced information 310 that pertains to a question received from a user. The crowd sourced information and metadata are harvested, or mined, from a number of crowd sourced data sets from various network-connected sites, such as social media websites 315. In one embodiment, crowd sourced information evaluator 300 is incorporated in a question/answer (QA) system, such as QA system 100 shown in FIG. 1, while in other embodiments, crowd sourced information evaluator 300 is a separate system that provides crowd sourced knowledge to the QA system. Crowd sourced metadata 305 is “data of data” and is related to crowd sourced information 310. Crowd sourced information may include opinions, ideas, and the like that are gathered from crowd based sources, such as social media websites 315. Crowd metadata 305 is data describing the crowd sourced information. As such, crowd metadata 305 can include items such as tags, keywords, “likes,” interests, gamifications, votes, reads, accesses, counts, and comments pertaining to the crowd sourced information.

QA system pipeline 320 shows a pipeline utilized by the QA system with crowd sourced information evaluator 300 providing inputs of crowd sourced information and adjusted scoring of answers/evidence. QA system pipeline 320 includes a number of steps used to process a user's question and return a most likely answer. Step 325 is question and topic analysis which may include identifying whether the user's question is requesting an answer that might be included in crowd sourced information 310, such as a question requesting opinions or ideas. Step 330 is question decomposition which identifies question keywords (and synonyms) found in the user's question. Step 340 is a primary search where the QA system searches for possible answers to the user's question with crowd sourced information being included in the primary search. Step 350 is candidate answer generation that generates candidate answers based upon the primary search. Step 360 is candidate answer scoring. During candidate answer scoring, crowd metadata is used to adjust the scores of the candidate answers. Candidate answers with more social support (e.g., “likes,” interests, gamifications, votes, reads, accesses, counts, comments, etc.) from the user community are provided with a larger adjustment than those candidate answers with less social support. Step 370 is supporting evidence retrieval for each of the candidate answers. Supporting evidence can include crowd sourced information and metadata. Step 380 is deep evidence scoring. During deep evidence scoring, crowd metadata is used to provide weights to the retrieved supporting evidence. Supporting evidence with more social support from the user community are provided with a greater weight, and thus more influence, than supporting evidence with less social support. Finally, at step 390 final merging and ranking of the supporting evidence and candidate answers takes place. The final ranking results in one of the candidate answers being the “best” ranked candidate answer. This best ranked candidate answer is returned to the user as the most likely answer to the user's question.

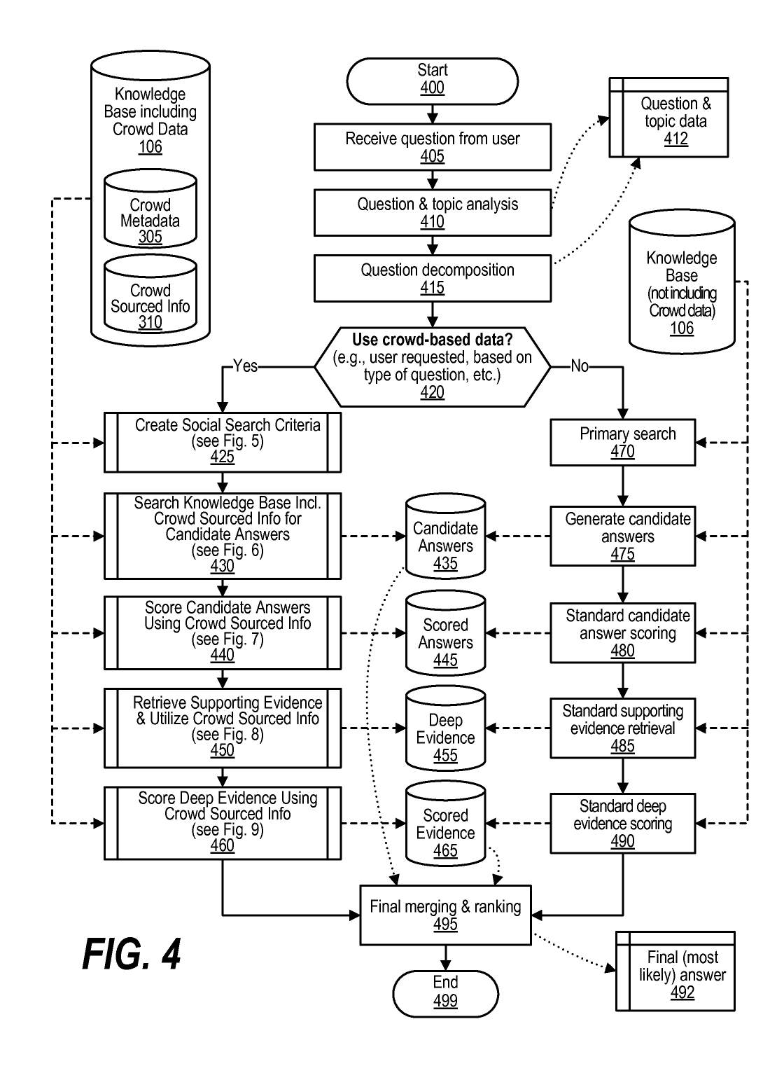

FIG. 4 is a depiction of a flowchart showing the logic used in the QA system using crowd sourced information to answer user questions. Processing commences at 400 whereupon, at step 405, the process receives a question from a user. At step 410, the process performs question and topic analysis and at step 415, the process performs question decomposition. The question-based data, such as keywords included in the question and the context of the question, are stored in memory area 412.

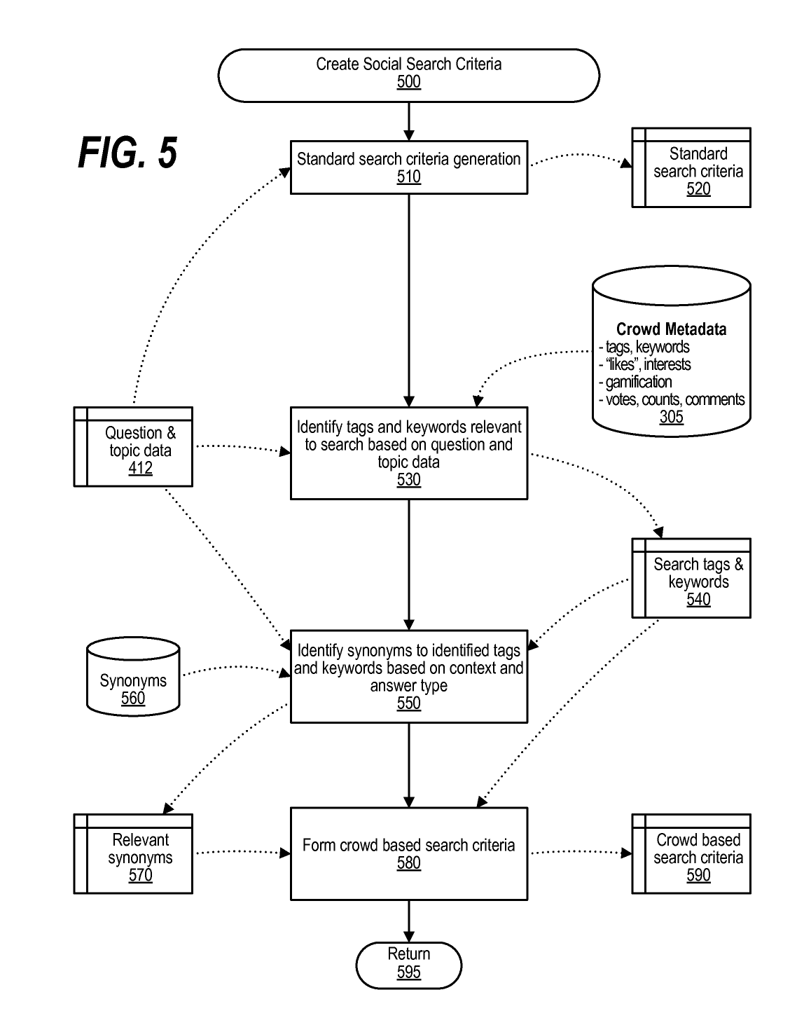

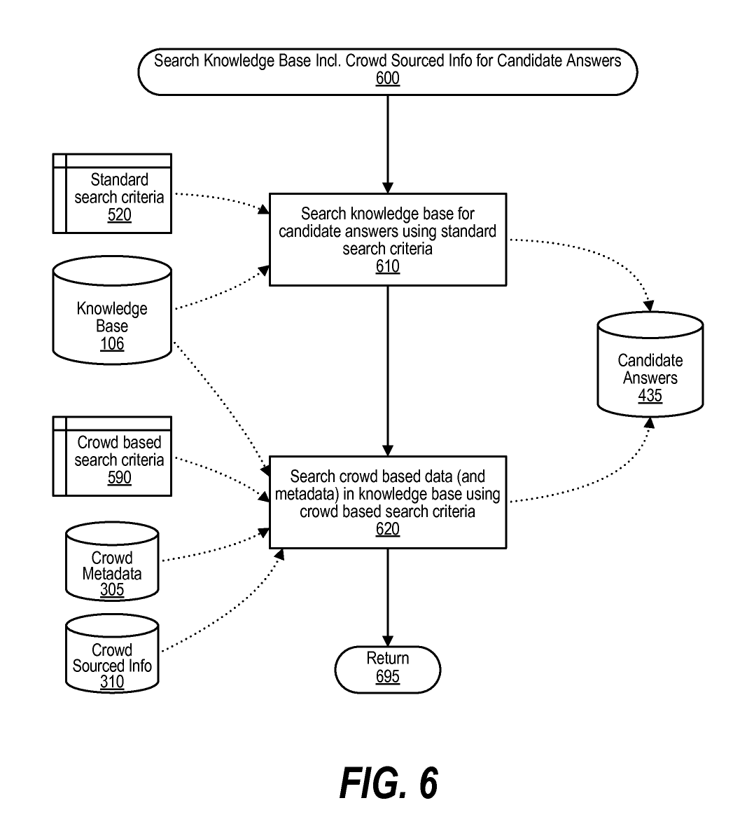

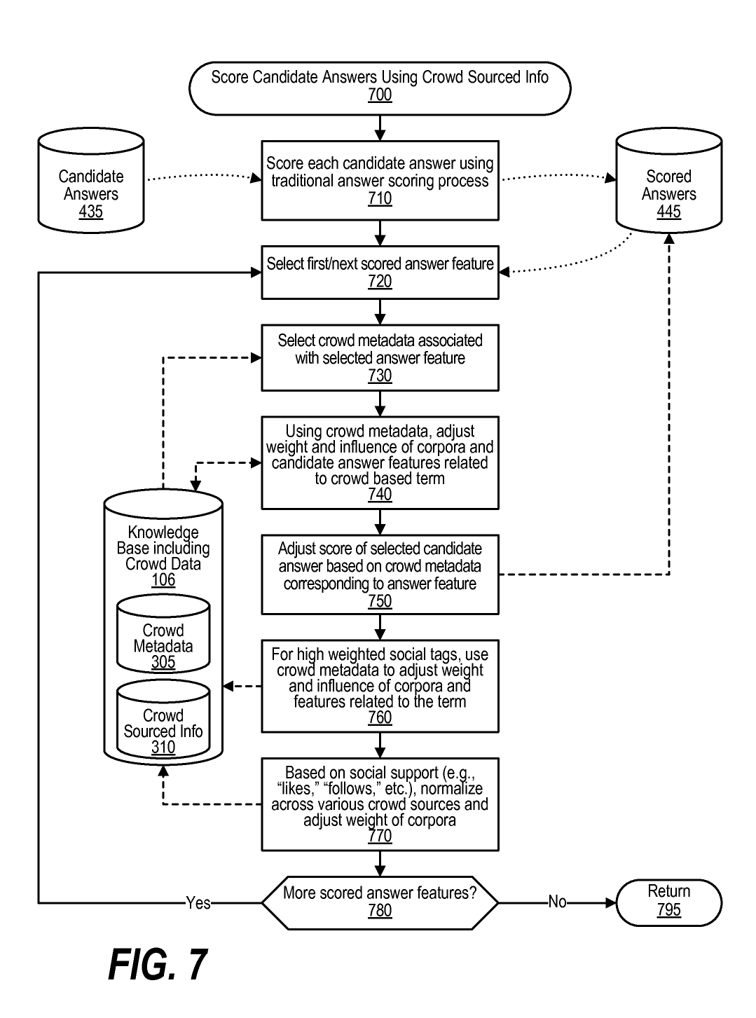

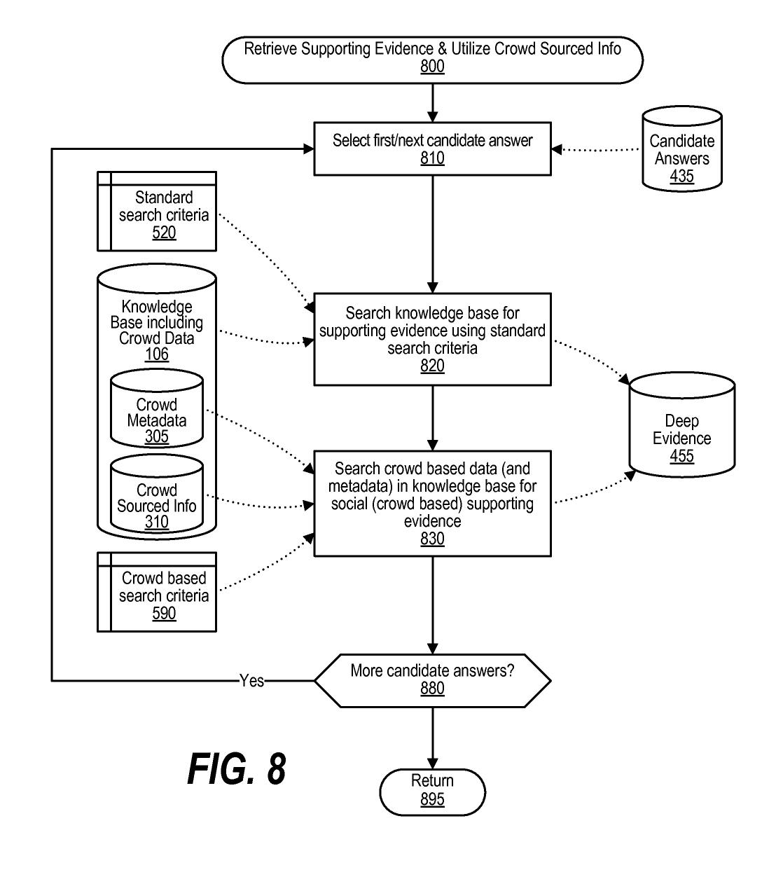

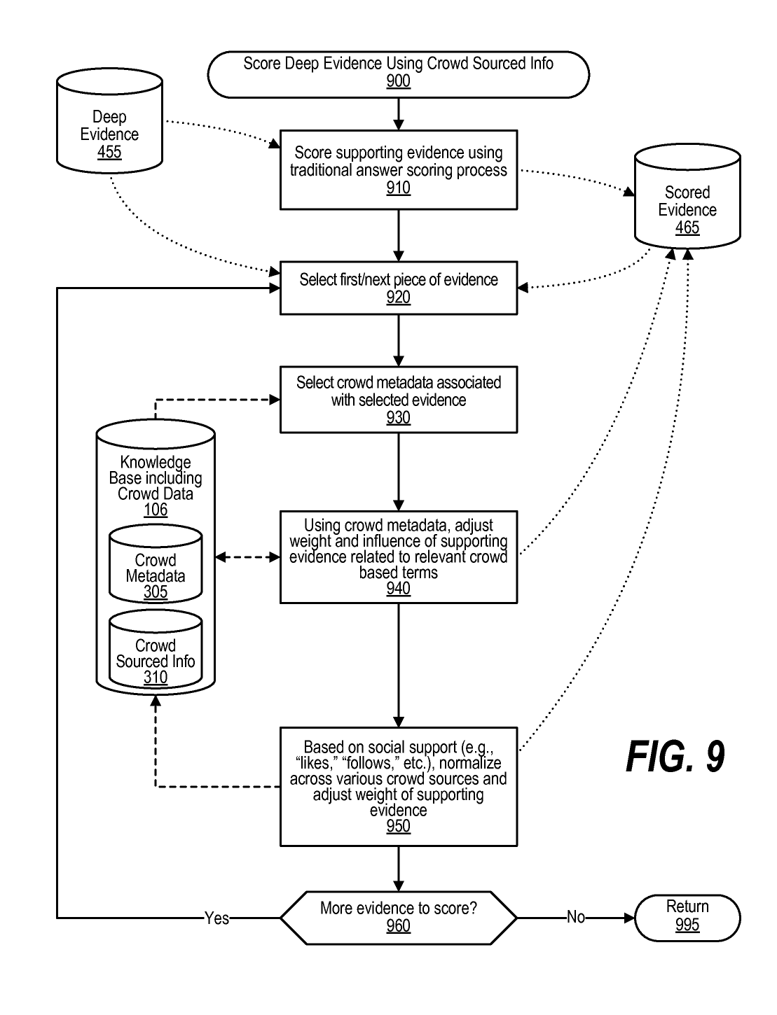

A determination is made as to whether to use crowd sourced data to answer the user's question (decision 420). This decision might be made based upon a specific user request to use crowd sourced data, based on the type of question asked by the user (e.g., a question calling for an opinion or idea from a user community, etc.), or on some other criteria. If crowd sourced data is being used to respond to the user's question, then decision 420 branches to the “yes” branch for further processing. At predefined process 425, the process creates a social search criteria that will be used to search the crowd sourced data (see FIG. 5 and corresponding text for further processing details). At step predefined process 430, the process searches the QA system's knowledge base that includes crowd sourced data (crowd sourced metadata and information) in order to generate candidate answers that are stored in data store 435 (see FIG. 6 and corresponding text for further processing details). At predefined process 440, the process scores the candidate answers using crowd sourced data including the crowd sourced metadata (see FIG. 7 and corresponding text for further processing details). The scored candidate answers are stored in data store 445. At predefined process 450, the process retrieves supporting evidence for each of the candidate answers with the supporting evidence being retrieved from the knowledge base that includes crowd sourced information and metadata (see FIG. 8 and corresponding text for further processing details). The supporting evidence is stored in data store 455. At predefined process 460, the process scores the supporting evidence using crowd sourced metadata (see FIG. 9 and corresponding text for further processing details).

Returning to decision 420, if crowd sourced data is not being used to respond to the user's question, then decision 420 branches to the “yes” branch whereupon standard process is performed using steps 475 through 490. Steps 475 through 490 utilize knowledge base 106 without including crowd sourced information or metadata. At step 470, a primary search is performed by the process using knowledge base 106. At step 475, the process generates candidate answers from the primary search with the candidate answers being stored in data store 435. At step 480, the process scores the candidate answers using a standard answer scoring algorithm with the scored candidate answers being stored in data store 445. At step 485, the process retrieves supporting evidence pertaining to the candidate answers using a standard supporting evidence retrieval process with the supporting evidence stored in data store 455. Finally, at step 490, the process scores, or weights, the retrieved supporting evidence with the scored supporting evidence stored in data store 465.

At step 495, the process performs a final merging and ranking process using the scored candidate answers from data store 445 and the scored (weighted) evidence from data store 465. The final, or most likely, answer is stored in memory area 492 and is returned to the user. In one embodiment, the final, or most likely, answer is a set of candidate answers ordered by their respective probabilities of being the correct answer. In a further embodiment, the respective probabilities are returned, and displayed, to the user along with the candidate answers. The process thereafter ends at 499.

FIG. 5 is a depiction of a flowchart showing the logic performed in creating a social search criteria to answer user questions. Processing commences at 500 whereupon, at step 510, the process generates standard search criteria using the question and topic data retrieved from memory area 412. The standard search criteria is used to search the knowledge base not including the crowd sourced information and metadata.

At step 530, the process identifies tags and keywords from the question and topic data with the identified tags and keywords being relevant to search the crowd sourced metadata. In one embodiment, the identification is made by matching keywords and context from the question and topic data with crowd sourced metadata retrieved from data store 305. The identified tags and keywords are stored in memory area 540.

At step 550, the process identifies synonyms corresponding to the identified tags and keywords based on the context and answer type retrieved from memory area 412. Available synonyms are retrieved from data store 560 and the relevant synonyms corresponding to the identified tags and keywords are stored in memory area 570.

At step 580, the process generates search criteria that is based on the crowd sourced data. The generation of the search criteria is based on the search tags and keywords from memory area 540 and the relevant synonyms from memory area 570. The crowd-based search criteria is stored in memory area 590. Processing thereafter returns to the calling routine (see FIG. 4) at 595.

FIG. 6 is a depiction of a flowchart showing the logic used in searching the knowledge base including crowd sourced information for candidate answers. Processing commences at 600 whereupon, at step 610, the process searches the knowledge base for candidate answers using the standard search criteria that was previously stored in memory area 520. In one embodiment, the knowledge base searched at step 610 does not include the crowd sourced information or metadata. The candidate answers resulting from step 610 are stored in data store 435.

At step 620, the process searches the knowledge base for candidate answers using the crowd-based search criteria that was previously stored in memory area 590. The knowledge base searched at step 620 includes crowd sourced information 310 and crowd sourced metadata 305. The candidate answers resulting from step 620 are stored in data store 435 along with the candidate answers that were stored as result of step 610. Processing thereafter returns to the calling routine (see FIG. 4) at 695.

FIG. 7 is a depiction of a flowchart showing the logic performed in scoring candidate answers using crowd sourced information. Processing commences at 700 whereupon, at step 710, the process retrieves candidate answers from data store 435, scores the candidate answers using traditional scoring techniques, and stores the scored candidate answers in data store 445. In one embodiment, the traditional scoring techniques are used to score each of the candidate answers, while in another embodiment, the traditional scoring techniques are only used to score the candidate answers that were gathered from non-crowd sourced data by step 610 shown in FIG. 6.

Returning to FIG. 7, at step 720, the process selects the first scored answer feature from data store 445. In one embodiment, step 720 selects all of the answer features stored in data store 445, while in another embodiment, step 720 only selects those answer features that were gathered from crowd sourced data by step 620 shown in FIG. 6. Returning again to FIG. 7, at step 730, the process selects crowd sourced metadata associated with the selected answer feature. At step 740, the process uses the crowd sourced metadata to adjust the weight and influence of the corpora (knowledge base 106) and candidate answer features that are related to the crowd-based term.

At step 750, the process adjusts the score of the selected candidate answer based on the crowd sourced metadata that corresponds to the answer feature. The adjusted scored candidate answers are maintained in data store 445. At step 760, the process identifies highly weighted social tags and uses the crowd metadata to adjust the weight and influence of the corpora and the features related to the term with the adjustment being made to knowledge base 106.

At step 770, the process normalizes social support for the selected answer feature across the various crowd sourced data sets corresponding to the various social media sources that provided the crowd sourced information and crowd sourced metadata. Based on the normalized social support, the process adjusts the weight of the selected answer feature in the corpora (knowledge base 106).

A determination is made as to whether there are more answer features stored in data store 445 to process (decision 780). If there are more answer features to process, then decision 780 branches to the “yes” branch which loops back to select and process the next answer feature as described above. This looping continues until all of the answer features have been processed, at which point processing returns to the calling routine (see FIG. 4) at 795.

FIG. 8 is a depiction of a flowchart showing the logic performed in retrieving supporting evidence which utilizes crowd sourced information. Processing commences at 800 whereupon, at step 810, the process selects the first candidate answer from data store 435. At step 820, the process searches knowledge base 106 for supporting evidence related to the selected candidate answer using a standard search criteria retrieved from memory area 520. In one embodiment, step 820 searches the non-crowd sourced data included in knowledge base 106. The supporting evidence found by step 820 is stored in data store 455. In one embodiment, step 820 is performed on all candidate answers, while in another embodiment, step 820 is only performed on those candidate answers that were generated using non-crowd sourced data.

At step 830, the process searches knowledge base 106 for supporting evidence related to the selected candidate answer using a crowd-based search criteria retrieved from memory area 590. In one embodiment, step 830 searches the crowd sourced data (crowd sourced metadata 305 and crowd sourced information 310) included in knowledge base 106. The supporting evidence found by step 830 is stored in data store 455 along with the supporting evidence stored by step 820. In one embodiment, step 830 is performed on all candidate answers, while in another embodiment, step 820 is only performed on those candidate answers that were generated using crowd sourced data.

A determination is made as to whether there are more candidate answers stored in data store 435 to process (decision 880). If there are more candidate answers to process, then decision 880 branches to the “yes” branch which loops back to select and process the next candidate answer as described above. This looping continues until all of the candidate answers have been processed, at which point processing returns to the calling routine (see FIG. 4) at 895.

FIG. 9 is a depiction of a flowchart showing the logic performed in scoring the evidence using crowd sourced information. Processing commences at 900 whereupon, at step 910, the process scores (weights) supporting evidence using traditional answer scoring process. The supporting evidence is retrieved from data store 455 and the weighted supporting evidence is stored in data store 465. In one embodiment, step 910 is used to provide weighting to all of the supporting evidence, while in another embodiment, step 910 is only used to provide weighted to the supporting evidence that was retrieved from non-crowd sourced data included in knowledge base 106.

At step 920, the process selects the first piece of supporting evidence from either data store 455 or data store 465. In one embodiment, step 920 selects each piece of supporting evidence, while in another embodiment, step 920 only selects those pieces of supporting evidence that were retrieved from crowd sourced data (crowd sourced metadata 305 and crowd sourced information 310) included in knowledge base 106.

At step 930, the process selects the crowd sourced metadata from data store 305 that is associated with the selected piece of supporting evidence. At step 940, using the crowd sourced metadata, the process adjusts the weight and influence of the supporting evidence that is associated with the relevant crowd based terms. The adjustments to the supporting evidence are made to the scored evidence stored in data store 465 as well as to supporting evidence included in the crowd sourced data included in knowledge base 106.

At step 950, the process normalizes social support for the selected piece of supporting evidence across the various crowd sourced data sets corresponding to the various social media sources that provided the crowd sourced information and crowd sourced metadata. Based on the normalized social support, the process adjusts the weight of the selected piece of supporting evidence in the corpora (knowledge base 106) and in the scored supporting evidence stored in data store 465.

A determination is made as to whether there are more pieces of supporting evidence to process (decision 960). If there are more pieces of supporting evidence to process, then decision 960 branches to the “yes” branch which loops back to select and process the next piece of supporting evidence as described above. This looping continues until all of the pieces of supporting evidence have been processed, at which point processing returns to the calling routine (see FIG. 4) at 995.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method, in an information handling system comprising a processor and a memory, of utilizing crowd sourced metadata to weigh candidate answers in a question/answer (QA) system, the method comprising:
receiving a question from a user;
identifying one or more question keywords and a context in the question using natural language processing (NLP);
mining a plurality of crowd sourced data sets for crowd sourced information, wherein the mining is based on the identified question keywords and context, and wherein the crowd sourced data sets have stored therein a collective opinion of a crowd of individuals;
evaluating the mined crowd sourced information based on a social support attribute included in a crowd sourced metadata, wherein the evaluating results in a most likely answer that is scored based on the social support attribute; and
returning the resulting most likely answer to the user.

2. The method of claim 1 wherein a knowledge base comprises the crowd sourced information and the crowd sourced metadata, and wherein the method further comprises:
identifying one or more of the crowd sourced metadata based on the identified question keywords and the identified question context; and
creating a social search criteria based on the identified crowd sourced metadata.

3. The method of claim 2 further comprising:
searching the crowd sourced information using the social search criteria, the result of the searching being a plurality of candidate answers.

4. The method of claim 3 further comprising:
identifying the crowd metadata associated with the plurality of candidate answers;
determining a metadata strength of the identified crowd metadata, wherein the metadata strength is based on one or more factors, and wherein at least one of the factors relates to a social support of an opinion; and
scoring the plurality of candidate answers based on an association of the identified crowd metadata to each of the candidate answers.

5. The method of claim 4 further comprising:
searching the knowledge base for supporting evidence pertaining to each of the candidate answers;
selecting the crowd metadata associated with each piece of supporting evidence resulting from the searching of the knowledge base; and
adjusting a weight associated with each piece of supporting evidence based on the selected crowd metadata associated with each piece of supporting evidence, wherein the weight relates to an influence that the supporting evidence is given during evaluation.

6. The method of claim 5 further comprising:
merging the supporting evidence based on the weights associated with each piece of supporting evidence;
ranking the plurality of candidate answers based on the scoring and based upon the merged supporting evidence; and
selecting a best ranked candidate answer as the most likely answer that is returned to the user.

7. The method of claim 1 wherein the crowd sourced metadata is selected from a group consisting of one or more tags, one or more keywords, one or more user accesses, one or more user votes, one or more user indicted “likes,” one or more follows, one or more user comments, a number of user subscribers, and one or more gamifications.

8. An information handling system comprising:
one or more processors;
a memory coupled to at least one of the processors;
a set of instructions stored in the memory and executed by at least one of the processors to utilize crowd sourced metadata to weigh candidate answers in a question/answer (QA) system, wherein the set of instructions perform actions of:
receiving a question from a user;
identifying one or more question keywords and a context in the question using natural language processing (NLP);
mining a plurality of crowd sourced data sets for crowd sourced information, wherein the mining is based on the identified question keywords and context, and wherein the crowd sourced data sets have stored therein a collective opinion of a crowd of individuals;
evaluating the mined crowd sourced information based on a social support attribute included in a crowd sourced metadata, wherein the evaluating results in a most likely answer that is scored based on the social support attribute; and
returning the resulting most likely answer to the user.

9. The information handling system of claim 8 wherein a knowledge base comprises the crowd sourced information and the crowd sourced metadata, and wherein the actions further comprise:
identifying one or more of the crowd sourced metadata based on the identified question keywords and the identified question context; and
creating a social search criteria based on the identified crowd sourced metadata.

10. The information handling system of claim 9 wherein the actions further comprise:
searching the crowd sourced information using the social search criteria, the result of the searching being a plurality of candidate answers.

11. The information handling system of claim 12 wherein the actions further comprise:
identifying the crowd metadata associated with the plurality of candidate answers;
determining a metadata strength of the identified crowd metadata, wherein the metadata strength is based on one or more factors, and wherein at least one of the factors relates to a social support of an opinion; and
scoring the plurality of candidate answers based on an association of the identified crowd metadata to each of the candidate answers.

12. The information handling system of claim 11 wherein the actions further comprise:
searching the knowledge base for supporting evidence pertaining to each of the candidate answers;
selecting the crowd metadata associated with each piece of supporting evidence resulting from the searching of the knowledge base; and
adjusting a weight associated with each piece of supporting evidence based on the selected crowd metadata associated with each piece of supporting evidence, wherein the weight relates to an influence that the supporting evidence is given during evaluation.

13. The information handling system of claim 12 wherein the actions further comprise:
merging the supporting evidence based on the weights associated with each piece of supporting evidence;
ranking the plurality of candidate answers based on the scoring and based upon the merged supporting evidence; and
selecting a best ranked candidate answer as the most likely answer that is returned to the user.

14. The information handling system of claim 8 wherein the crowd sourced metadata is selected from a group consisting of one or more tags, one or more keywords, one or more user accesses, one or more user votes, one or more user indicted “likes,” one or more follows, one or more user comments, a number of user subscribers, and one or more gamifications.

15. A computer program product stored in a computer readable storage medium, comprising computer instructions that, when executed by an information handling system, causes the information handling system to utilize crowd sourced metadata to weigh candidate answers in a question/answer (QA) system by performing actions comprising:
receiving a question from a user;
identifying one or more question keywords and a context in the question using natural language processing (NLP);
mining a plurality of crowd sourced data sets for crowd sourced information, wherein the mining is based on the identified question keywords and context, and wherein the crowd sourced data sets have stored therein a collective opinion of a crowd of individuals;
evaluating the mined crowd sourced information based on a social support attribute included in a crowd sourced metadata, wherein the evaluating results in a most likely answer that is scored based on the social support attribute; and
returning the resulting most likely answer to the user.

16. The computer program product of claim 15 wherein a knowledge base comprises the crowd sourced information and the crowd sourced metadata, and wherein the actions further comprise:
identifying one or more of the crowd sourced metadata based on the identified question keywords and the identified question context; and
creating a social search criteria based on the identified crowd sourced metadata.

17. The computer program product of claim 16 wherein the actions further comprise:
searching the crowd sourced information using the social search criteria, the result of the searching being a plurality of candidate answers.

18. The computer program product of claim 17 wherein the actions further comprise:
identifying the crowd metadata associated with the plurality of candidate answers;
determining a metadata strength of the identified crowd metadata, wherein the metadata strength is based on one or more factors, and wherein at least one of the factors relates to a social support of an opinion; and
scoring the plurality of candidate answers based on an association of the identified crowd metadata to each of the candidate answers.

19. The computer program product of claim 18 wherein the actions further comprise:
searching the knowledge base for supporting evidence pertaining to each of the candidate answers;
selecting the crowd metadata associated with each piece of supporting evidence resulting from the searching of the knowledge base; and
adjusting a weight associated with each piece of supporting evidence based on the selected crowd metadata associated with each piece of supporting evidence, wherein the weight relates to an influence that the supporting evidence is given during evaluation.

20. The computer program product of claim 18 wherein the actions further comprise:
merging the supporting evidence based on the weights associated with each piece of supporting evidence;
ranking the plurality of candidate answers based on the scoring and based upon the merged supporting evidence; and
selecting a best ranked candidate answer as the most likely answer that is returned to the user.
